(19) United States
(12) Patent Application Publication
(10) Pub. No.: US 2006/0110208 A1
(43) Pub. Date: May 25, 2006

(54) Compressible container with sealing means

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/998,066

(22) Filed: Nov. 24, 2004

(51) Int. Cl. B65D 35/22; B43K 5/00; B43M 11/06

(52) U.S. Cl. 401/205; 401/185; 401/186

(57) ABSTRACT

The compressible container with sealing means is a compressible single dose container that comprises of a compressible elongated container enclosing a substance with a viscous substance disposed therein between the substance and an open end of the compressible elongated container to prevent spillage and minimize evaporation of the substance.

### BACKGROUND

1. Field of Invention

The present invention relates generally to a small compressible container. More specifically, the present invention relates to a compressible single dose elongated container with a sealing means.

2. Description of Related Art

Various containers are used in the prior art to enclose and hold substances such as liquids and viscous substances. The containers may be in various sizes ranging from large water tanks to small single dose medicinal containers.

Containers are generally provided with a cover, such as a screw-on cap to completely seal its contents and prevent spills during transport and storage. However, the addition of a cover increases the cost of the container and requires an additional step of opening the container prior to using its content. These shortcomings, particularly when the container is a single dose container, are not only inconvenient but may be cost prohibitive at times.

### BRIEF SUMMARY OF THE INVENTION

An object of the present invention is to provide a small compressible container that does not require a cover. Another object of the present invention is to enable a small compressible container to be manufactured economically and at a fast rate. Yet another object of the present invention is to provide a small compressible single dose container that is convenient and easy to use.

The compressible container with sealing means comprises of a compressible elongated container with an enlarged section enclosing a substance with a viscous substance disposed therein between the substance and an open end of the compressible elongated container to seal the substance within the compressible elongated container.

### BRIEF DESCRIPTION OF THE DRAWINGS

FIG. 1 shows the preferred embodiment of the compressible container with sealing means.

FIG. 2 shows another embodiment of the compressible container with sealing means.

FIG. 3 shows another embodiment of the compressible container with sealing means.

FIG. 4 shows another embodiment of the compressible container with sealing means.

FIG. 5 shows another embodiment of the compressible container with sealing means.

FIG. 6 shows another embodiment of the compressible container with sealing means.

FIG. 7 shows another embodiment of the compressible container with sealing means.

FIG. 8 shows another embodiment of the compressible container with sealing means.

FIG. 9 shows another embodiment of the compressible container with sealing means.

FIG. 10 shows another embodiment of the compressible container with sealing means.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

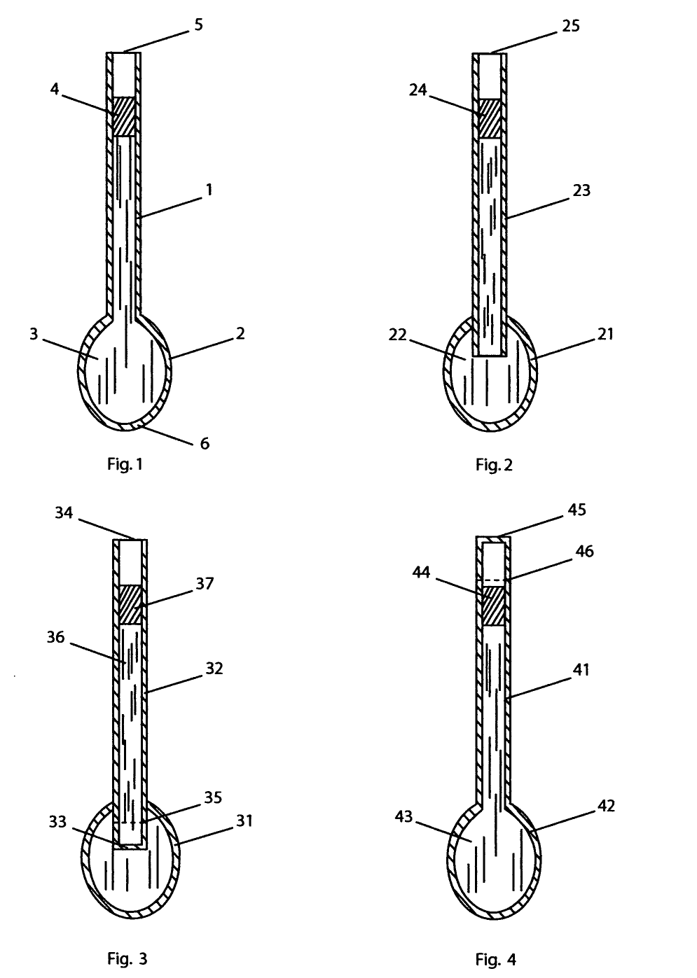

In the preferred embodiment, the compressible container with sealing means comprises of a compressible elongated container 1 with an enlarged section 2 in the general shape of a sphere at one extremity of the compressible elongated container 1 enclosing a substance 3 therein with a viscous substance 4 disposed between the substance 3 and an open end 5 of the compressible elongated container 1 to seal the substance 3 in the compressible elongated container 1 as shown in FIG. 1. The compressible elongated container 1 is preferably made of plastic such as polypropylene or polyethylene. A substance 3, such as a liquid or medication, is enclosed in the compressible elongated container 1 near a sealed end 6 of the container 1. The viscous substance 4 near the open end 5 of the compressible elongated container will function as a sealer to seal the substance 3 in the compressible elongated container 1.

The substance 3 in the compressible elongated container 1 is completely sealed in the container 1 by the compressible elongated container 1 and the viscous substance 4 prior to use. At the time of application, the container 1 only needs to be compressed, such as with the user's fingers, at the general position of the substance 3 or at the enlarged section 2 of the compressible elongated container 1 to force the substance 3 in the compressible elongated container 1 through the viscous substance 4 to extract the substance 3 out from the open end 5 of the container 1. Optionally, the open end 5 of the container 1 may be surrounded or covered with an applicator tip. The applicator tip may be an absorbent material such as cotton, foam, or sponge. The compressible elongated container 1 will effectively act as the applicator for the content of the container 1 after the substance 3 in the container 1 is compressed out of the container 1 into the applicator tip.

FIG. 2 shows another embodiment of the present invention. In this embodiment, the compressible container with sealing means comprises of a compressible container 21 enclosing a substance 22 therein. An elongated tube 23 is inserted into and affixed to the compressible container 21. A viscous substance 24 is disposed in the elongated tube 23 positioned between the substance 22 and an open end 25 of the elongated tube 23 to seal the substance 22 in the compressible container 21. The compressible container 21 is preferably made of plastic such as polypropylene or polyethylene. The viscous substance 24 is preferably silicone. In this embodiment, the elongated tube 22 may be made of a different material than the compressible container 21 and may also be made of a stiffer material to resist bending and compression.

FIG. 3 shows another embodiment of the present invention. In this embodiment, the compressible container with sealing means comprises of a compressible container 31. An elongated tube 32 with a sealed end 33 and an open end 34 is inserted into and affixed to the compressible container 31 with the sealed end 33 inside the compressible container 31. An opening means 35 in the form of a fracture line is positioned near the sealed end 33 of the elongated tube 32. A substance 36 is disposed inside the elongated tube 32 near the sealed end 33 of the elongated tube 32. A viscous substance 37 is disposed in the elongated tube 32 positioned between the substance 36 and an open end 34 of the elongated tube 32 to seal the substance 36 in the elongated tube 32. The compressible container 31 is preferably made of plastic such as polypropylene or polyethylene. The viscous substance 37 is preferably silicone. In this embodiment, the elongated tube 32 may be made of a different material than the compressible container 31 and may also be made of a stiffer material to resist bending and compression.

FIG. 4 shows another embodiment of the compressible container with sealing means. In this embodiment, the compressible container with sealing means comprises of a compressible elongated container 41 with an enlarged section 42 at one extremity of the compressible elongated container 41 enclosing a substance 43 therein with a viscous substance 44 disposed between the substance 43 and a sealed end 45 of the compressible elongated container 41. An opening means 46, preferably in the form of a fracture line, is formed on the compressible elongated container 41 between the sealed end 45 of the compressible elongated container 41 and the viscous substance 44. The compressible elongated container 41 is preferably made of plastic such as polypropylene or polyethylene. The viscous substance 44 near the sealed end 45 of the compressible elongated container 41 will function as a sealer to seal the substance 43 in the compressible elongated container 41 after the compressible elongated container 41 is opened at the opening means 46. The viscous substance 44 will further separate the substance 43 in the compressible elongated container 41 from the opening means 46 thereby prevent the spewing of the substance 43 through the resulting opening when the opening means 46 is opened.

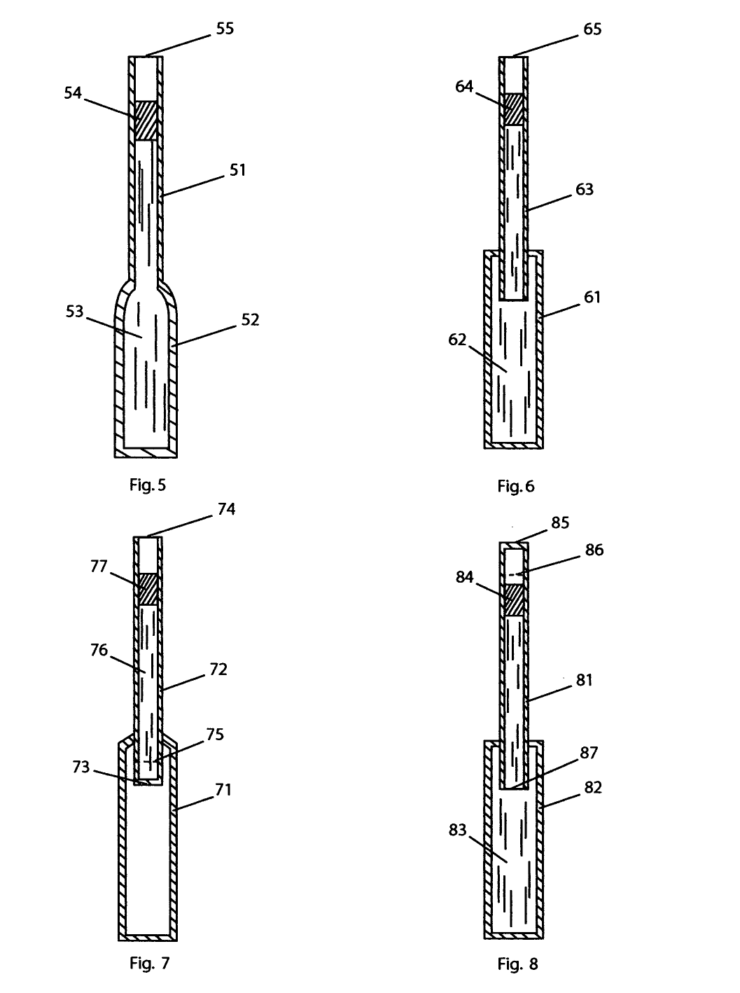

Yet another embodiment of the compressible container with sealing means is shown in FIG. 5. In this embodiment, the compressible container with sealing means comprises of a compressible elongated container 51 with an enlarged section 52 in a generally cylindrical shape at one extremity of the compressible elongated container 51 enclosing a substance 53 therein with a viscous substance 54 disposed between the substance 53 and an open end 55 of the compressible elongated container 51 to seal the substance 53 in the compressible elongated container 51.

FIG. 6 shows another embodiment of the present invention. In this embodiment, the compressible container with sealing means comprises of a compressible container 61 in the general shape of a cylinder enclosing a substance 62 therein. An elongated tube 63 is inserted into and affixed to the compressible container 61. A viscous substance 64 is disposed in the elongated tube 63 positioned between the substance 62 and an open end 65 of the elongated tube 63 to seal the substance 62 in the compressible container 61. In this embodiment, the elongated tube 63 may be made of a different material than the compressible container 61 and may also be made of a stiffer material to resist bending and compression.

FIG. 7 shows another embodiment of the present invention. In this embodiment, the compressible container with sealing means comprises of a compressible container 71 in the general shape of a cylinder. An elongated tube 72 with a sealed end 73 and an open end 74 is inserted into and affixed to the compressible container 71 with the sealed end 73 inside the compressible container 71. An opening means 75 in the form of a fracture line is positioned near the sealed end 73 of the elongate tube 72 and located inside the compressible container 71 when the elongated tube 72 is inserted into the compressible container 71. A substance 76 is disposed inside the elongated tube 72 near the sealed end 73 of the elongated tube 72. A viscous substance 77 is disposed in the elongated tube 72 positioned between the substance 76 and the open end 74 of the elongated tube 72 to seal the substance 76 in the elongated tube 72. In this embodiment, the elongated tube 72 may be made of a different material than the compressible container 71 and may also be made of a stiffer material to resist bending and compression.

FIG. 8 shows another embodiment of the compressible container with sealing means. In this embodiment, the compressible container with sealing means comprises of a compressible elongated container 81 with an enlarged section 82 in the general shape of a cylinder at one extremity of the compressible elongated container 81 enclosing a substance 83 therein with a viscous substance 84 disposed between the substance 83 and a sealed end 85 of the compressible elongated container 81. An opening means 86, preferably in the form of a fracture line, is formed on the compressible elongated container 81 between the sealed end 85 of the compressible elongated container 81 and the viscous substance 84. The compressible container with sealing means may alternatively comprises of a compressible container 82 in the general shape of a cylinder. An elongated tube 81 with a sealed end 85 and an open end 87 is inserted into and affixed to the compressible container 82 with the open end 87 inside the compressible container 82. An opening means 86 in the form of a fracture line is positioned near the sealed end 85 of the elongate tube 81. The viscous substance 84 near the sealed end 85 of the compressible elongated container 81 will function as a sealer to seal the substance 83 in the compressible elongated container 82 after the compressible elongated container 82 is opened at the opening means 86. The viscous substance 84 will further separate the substance 83 in the compressible elongated container 82 from the opening means 86 thereby prevent the spewing of the substance 83 through the resulting opening when the opening means 86 is opened.

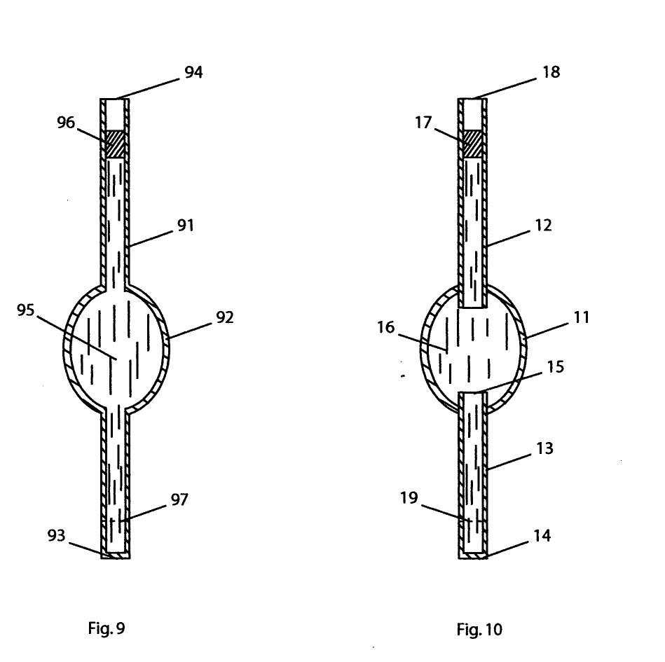

FIG. 9 shows another embodiment of the compressible container with sealing means. In this embodiment, the compressible container with sealing means comprises of a compressible elongated container 91 with an enlarged section 92 between the two ends 93, 94 of the compressible elongated container 91. A substance 95 is disposed in the compressible elongated container 91 with a viscous substance 96 disposed between the substance 95 and an open end 94 of the compressible elongated container 91 to seal the substance 95 in the compressible elongated container 91. An opening means 97, preferably a fracture line, is positioned near the sealed end 93 of the compressible elongated container 91. When the opening means 97 is operated to open the sealed end 93 of the compressible elongated container 91, the substance 95 enclosed in the compressible elongated container 91 may be released quickly without compressing the compressible elongated container 91.

FIG. 10 shows another embodiment of the compressible container with sealing means. In this embodiment, the compressible container with sealing means comprises of a compressible container 11 with a first hollow tube 12 inserted and affixed to the compressible container 11. A second hollow tube 13 with a sealed end 14 and an open end 15 is inserted with its open end 15 inside the compressible container 11 and affixed generally opposite to the first hollow tube 12. A substance 16 is disposed in the compressible container 11 with a viscous substance 17 disposed near an open end 18 of the first hollow tube 12 to seal the substance 16 in the compressible container 11. An opening means 19, preferably a fracture line, is positioned near the sealed end 14 of the second hollow tube 13. When the opening means 19 is operated to open the sealed end 14 of the second hollow tube 13, the substance 16 enclosed in the compressible container 11 may be released quickly without compressing the compressible container 11.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A compressible container with sealing means comprising:
a compressible container with an enlarged section at one extremity of said compressible container;
a substance disposed within said compressible container; and
a viscous substance disposed between said substance and an open end of said compressible container to seal said substance in said compressible container.

2. A compressible container with sealing means as in claim 1, wherein said compressible container is made of plastic.

3. A compressible container with sealing means as in claim 1, wherein said viscous substance is silicone.

4. A compressible container with sealing means as in claim 1, wherein an applicator tip is affixed to said open end of said compressible container.

5. A compressible container with sealing means as in claim 4, wherein said applicator tip is an absorbent material such as cotton, foam, or sponge.

6. A compressible container with sealing means as in claim 1, wherein said open end of said compressible container is sealed and an opening means is provided between said sealed open end and said viscous substance.

7. A compressible container with sealing means as in claim 6, wherein said opening means is a fracture line.

8. A compressible container with sealing means comprising:
a compressible container;
an elongated tube inserted into and affixed to said compressible container;
a substance disposed within said compressible container; and
a viscous substance disposed in said elongated tube positioned between said substance and an open end of said elongated tube to seal said substance in said compressible container.

9. A compressible container with sealing means as in claim 8, wherein said compressible container is made of plastic.

10. A compressible container with sealing means as in claim 8, wherein said viscous substance is silicone.

11. A compressible container with sealing means as in claim 8, wherein an applicator tip is affixed to said open end of said compressible container.

12. A compressible container with sealing means as in claim 11, wherein said applicator tip is an absorbent material such as cotton, foam, or sponge.

13. A compressible container with sealing means as in claim 8, wherein said open end of said elongated tube is sealed and an opening means is provided between said sealed open end and said viscous substance.

14. A compressible container with sealing means as in claim 13, wherein said opening means is a fracture line.

15. A compressible container with sealing means comprising:
a compressible container;
an elongated tube with an open end and a sealed end inserted into and affixed to said compressible container with said sealed end inside said compressible container and with an opening means provided near said sealed end;
a substance disposed within said elongated tube; and
a viscous substance disposed in said elongated tube positioned between said substance and said open end of said elongated tube to seal said substance in the elongated tube.

16. A compressible container with sealing means as in claim 15, wherein said compressible container is made of plastic.

17. A compressible container with sealing means as in claim 15, wherein said viscous substance is silicone.

18. A compressible container with sealing means as in claim 15, wherein an applicator tip is affixed to said open end of said compressible container.

19. A compressible container with sealing means as in claim 18, wherein said applicator tip is an absorbent material such as cotton, foam, or sponge.

20. A compressible container with sealing means as in claim 15, wherein said opening means is a fracture line.

21. A compressible container with sealing means comprising:
a compressible container with a sealed end and an open end and an enlarged section between said two ends with an opening means provided near said sealed end;
a substance disposed within said compressible container; and
a viscous substance disposed between said substance and said open end of said compressible container to seal said substance in said compressible container.

22. A compressible container with sealing means as in claim 21, wherein said compressible container is made of plastic.

23. A compressible container with sealing means as in claim 21, wherein said viscous substance is silicone.

24. A compressible container with sealing means as in claim 21, wherein an applicator tip is affixed to said open end of said compressible container.

25. A compressible container with sealing means as in claim 24, wherein said applicator tip is an absorbent material such as cotton, foam, or sponge.

26. A compressible container with sealing means as in claim 25, wherein said opening means is a fracture line.

27. A compressible container with sealing means comprising:
a compressible container;
a first hollow tube inserted and affixed to said compressible container;
a second hollow tube with a sealed end and an open end inserted with said open end inside said compressible container and affixed generally opposite to said first hollow tube and with an opening means provided near said sealed end;
a substance disposed in said compressible container; and
a viscous substance disposed near an open end of said first hollow tube to seal said substance in said compressible container.

28. A compressible container with sealing means as in claim 27, wherein said viscous substance is silicone.

29. A compressible container with sealing means as in claim 27, wherein an applicator tip is affixed to said open end of said compressible container.

30. A compressible container with sealing means as in claim 29, wherein said applicator tip is an absorbent material such as cotton, foam, or sponge.

31. A compressible container with sealing means as in claim 27, wherein said opening means is a fracture line.
